(19) United States
(12) Patent Application Publication
(10) Pub. No.: US 2001/0025714 A1
(43) Pub. Date: Oct. 4, 2001

(54) Torque transmission tool

(76) Inventor: Karl Lieser, Wuppertal (DE)

Correspondence Address: QUARLES & BRADY LLP, 411 E. WISCONSIN AVENUE, SUITE 2040, MILWAUKEE, WI, 53202-4497, US

(21) Appl. No.: 09/797,232

(22) Filed: Mar. 1, 2001

(30) Foreign Application Priority Data
Mar. 9, 2000 (DE) 10011506.3

(51) Int. Cl. B23Q 5/00

(52) U.S. Cl. 173/178; 173/176

(57) ABSTRACT

A tool, which can be used in the manner of a pinion, contains two parts, whereof one serves as the drive and the other as the driven part. The two parts form a cavity in which is inserted a torque-limiting clutch. The latter is positioned in axially floating manner, so that the once set clutch release torque can be maintained independently of external influences.

It is known that in most applications screws must be tightened with a certain torque and it is not possible to pass above or below this. To this end torque wrenches are known in which it is frequently possible to set the value at which further turning is no longer possible. Such torque-limiting tools are frequently constructed as ratchet wrenches or the like. They suffer from the disadvantage that a user who pressed on the tool in the longitudinal direction of the screw to be turned in order to avoid slipping off consequently influences the clutch built into the tool, so that it is no longer released at the set value.

The problem of the invention is to create a simply constructed torque-limiting tool, in which the set torque value cannot be changed.

For solving this problem the invention proposes a tool having the features of claim 1. Further developments of the invention form the subject matter of the dependent claims, whose wording, like that of the abstract, is by reference made into part of the content of the present description.

The tool contains a driving part at which the torque to be applied is introduced, together with a driven part, at which the torque to be transmitted is removed and between these two parts is interposed the actual torque-limiting clutch. The clutch is so connected to the driving parts that although it transmits the torque, in the axial direction it is unable to absorb any force from the driving part or the driven part. Thus, through pressing axially on the tool, there can be no adjustment of the once set release value.

According to a further development, this is e.g. brought about in that in the axial direction the clutch is neither connected to the driving part nor to the driven part, so that it is only connected to both parts in the turning direction.

For example, the clutch can be positioned and constructed in such a way that it is axially displaceably held with respect to the tool and said displaceability can be a short distance displacement.

The tool can be constructed in such a way that the driving part has such a shape and design that it is connectable with a driving tool either directly or by means of a square. It can e.g. directly have the shape of a square with which it is inserted in an opening of a ratchet wrench and can be secured there. However, it can also be designed in such a way that it has a square opening in which can be inserted a square projection of a ratchet wrench. It is obviously also possible to construct the driving part in such a way that a user can directly act on it using a spanner or a box wrench.

The driven part can e.g. be constructed in such a way that it is usable as a pinion, e.g. having a dodecagonal, standard inner opening.

According to a further development of the invention, the driving part and the driven part are in each case constructed in sleeve form and in whose common inner space or area, if the two sleeves are assembled, is housed the clutch. Here the clutch is housed so as to be protected against external influences, so that it is protected both against dirt and against intentional or unintentional adjustment.

According to a further development of the invention, the sleeves and at least one of the two sleeves, can have an inner cross-section differing from a circle and which is adapted to the outer cross-section of the clutch inlet or outlet. In this way and without further measures the non-rotary connection can be provided between the corresponding tool part and the clutch.

The cross-section can in particular be in the form of a regular polygon, e.g. a hexagon, such as is conventional with screw heads and nuts.

According to a further development of the invention, the cross-section of both sleeves is identical.

To adapt the tool to different applications, according to a further development of the invention the torque value at which the clutch transmits no torque can be set.

It can in particular be provided that the clutch has a wobbler or journal provided on both sides with a stop member and on which two clutch disks are displaceably mounted, which are pressed against one another by at least one spring. As a function of other clutch geometries, the spring strength defines the value at which the clutch is released.

The adjustability of the clutch release value can e.g. be implemented in that the spring is replaced. A stronger spring ensures a higher release value.

According to a further development of the invention, the pressing of the two clutch disks against one another can be implemented by two springs or two spring units, whereof each spring is in each case placed between a stop member and a coupling disk. This symmetry proposed by the invention leads to an improved, more precise clutch response.

For adjusting the clutch release value, a further development provides that at least one of the two stop members is adjustable in the longitudinal direction of the journal, particularly in fine steps or in stepless manner.

According to another further development of the invention, the position of the two clutch disks in the longitudinal direction of the journal can be modified without changing the clutch release value. Thus, the engaged clutch can have its position more precisely adapted to the positions of the two parts of the tool.

According to a further development of the invention, between the spring and the associated clutch disk and/or the associated stop member is provided a sliding disk. As soon as the clutch opens there is a twisting of the corresponding clutch disk with respect to the journal and/or spring. In order to reduce the resulting forces or damage, said sliding disk can be provided.

It can in particular be provided that one of the two stop members is formed by a one-piece head of the journal, whereas the other stop member, which is an adjustable stop, is formed by a nut, which is screwed onto a thread of the journal. By turning to a greater or lesser extent said nut can modify the initial stress of the clutch and consequently the release value.

The clutch disks are advantageously constructed in such a way that their facing clutch surfaces have a type of saw-tooth system, which permits a sliding of two teeth on one another.

According to a further development of the invention, the toothed systems of both clutch disks pass radially from a radius, which is larger than the opening of the clutch disks receiving the journal. Thus, on the edge or rim of the opening there is an initially still smooth area, so that a ring can be inserted between the two clutch disks preventing the complete engagement of the two clutch surfaces. This makes it possible to modify or set the value at which the clutch opens.

In particular, according to a further development, the outer circumference of the clutch disks forms the clutch inlet or outlet serving for torque introduction or reduction.

It is also possible and is proposed by the invention that the clutch is constructed as a sleeve, in whose inner area is placed the driving element and/or the driven element of the tool.

Further features, details and advantages of the invention can be gathered from the following description of a preferred embodiment thereof, together with the attached drawings, wherein show:

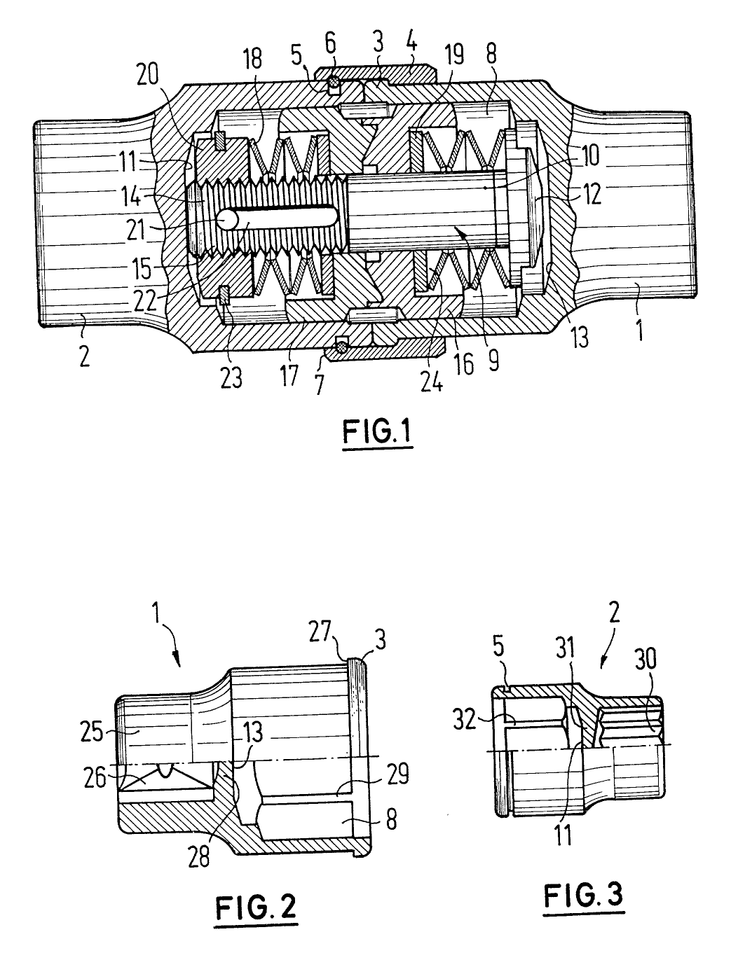

FIG. 1 A longitudinal section through a tool according to the invention.

FIG. 2 A part sectional side view of a first part of the tool.

FIG. 3 A part sectional side view of a second part of the tool.

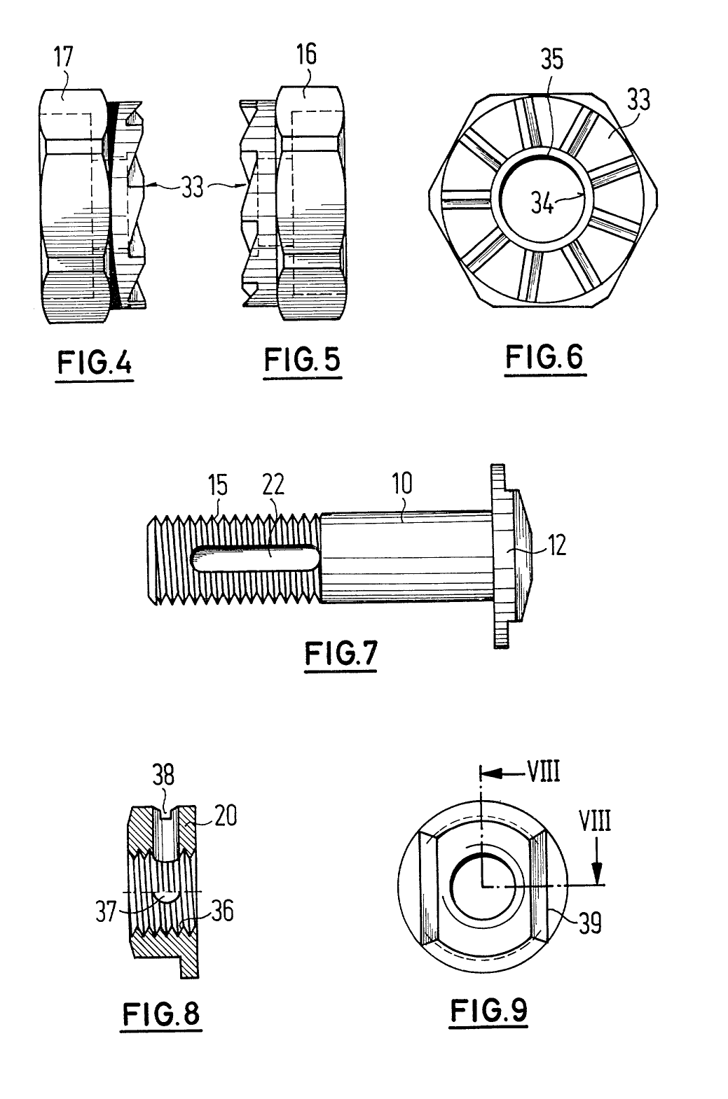

FIG. 4 The side view of one clutch disk.

FIG. 5 The side view of the second clutch disk.

FIG. 6 The front view of the clutch disk from the clutch surface.

FIG. 7 The side view of a journal used for implementing the clutch.

FIG. 8 A section through a stop nut.

FIG. 9 The front view of the stop nut of FIG. 8.

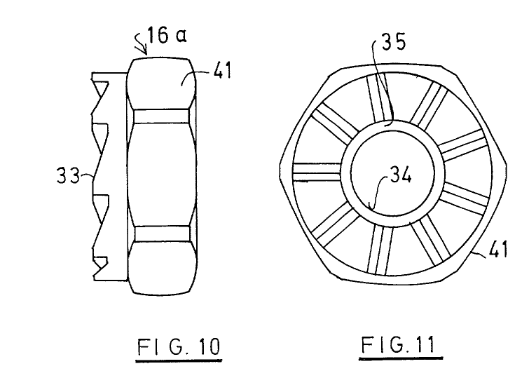

FIG. 10 A side view of one clutch disk of second embodiment.

FIG. 11 The front view of the clutch disk of FIG. 10.

FIG. 1 shows a central, sectional side view of a tool according to the invention. The tool is intended to transmit a torque up to a given level. Subsequently torque transmission is to be stopped. The tool contains a driving part, which can be connected in random manner with a driving tool, e.g. a spanner or ratchet wrench. To the opposite end of the tool is fitted a similarly constructed driven part 2, which is used for torque reduction purposes. It can be a spanner. The two parts are axially oriented and interconnected in rotary manner. In the vicinity of its end facing the driven part 2, the driving part 1 has a small, outer bead 3, which is used for limiting the closing movement of a ring 4, which is mounted on the cylindrical outside of the driving part 1. This ring is dimensioned in such a way that it can engage over the also cylindrical outside of the driven part 2, where a groove is provided, in which is located a circlip 6. In the vicinity of its free end 7, the ring 4 has on its inside a groove. If the two parts abut against one another with their free end faces, then the ring 4 is placed over the circlip 6 until it engages in both grooves and axially secures the tool. In the circumferential direction the two parts 1, 2 can be further turned, because the circlip 6 does not represent a circumferential obstacle.

In the vicinity of their facing sides both the driving part 1 and the driven part 2 are constructed as sleeves and consequently contain an inner area 8 forming a joint cavity. In said inner area 8 is housed a torque-limiting clutch 9, which will be described in greater detail hereinafter. It contains a wobbler or journal 10 which, coaxially to the tool, is positioned in freely resting manner in the area 8. In FIG. 1 admittedly its one end engages on an end wall 11 of the driven part 2, but the opposite end provided with a head 12 has a spacing from the corresponding end wall 13. Thus, the journal 12 can float axially in the inner area.

Starting from its head 12, the journal 10 firstly has a smooth-surfaced portion, to which is connected a threaded portion 14 with an external thread 15. On the shank 10 is lined up an arrangement with two clutch disks 16, 17, which can turn freely about the shank 10. On their facing surfaces, cf. FIG. 6, the clutch disks have a clutch tooth system, which is known per se. The two clutch disks 16, 17 are pressed against one another with the aid of two cup spring units in the embodiment shown. One cup spring unit 18 is supported on the underside of the head 12 of journal 10 and urges one clutch disk 16 away from this journal end. A sliding ring 19 is inserted between the cup spring unit 18 and the clutch disk 16.

On the opposite side the cup spring unit 18 is supported on a stop nut 20, which is screwed onto the internal thread 15 of the threaded portion 14. To prevent a turning of the nut 20, the latter has a cross hole through which is placed a pin 21, which simultaneously engages through an axial elongated hole 22 of the journal 10. The stop nut 20 contains a circlip 23 to prevent the sliding out of the journal 21.

The sleeve-like inner area 8 of both parts 1, 2 has a non-circular construction and a shape identical to the external shape of the clutch disks 16, 17, a certain clearance being provided. The transmission of torque from the driving part 1 to the driven part 2 takes place in such a way that the rotation forced onto the driving part 1 is transmitted as a result of the non-circular inner shape of the inner area 8 to the clutch disk 16. As the clutch disk 16 is under spring tension engagement with the opposite clutch disk 17, the latter is also rotated and its rotation is transmitted through its outer shape to the driven part 2.

If e.g. on tightening a screw the resistance on the driven part 2 increases, then a higher torque must be transmitted. Due to the engagement of the inclined faces of the coupling surfaces the higher torque leads to the clutch disks 16 being separated from one another counter to the action of the cup spring units 18. This continues until the two clutch disks become disengaged. As from this time the driving part 1 continues to turn, whereas the driven part 2 remains stationary, because it is no longer driven. Thus, the tool transmits the torque from the driven part to the clutch and from the latter to the driven part. If a user presses on the driving part 1 in order to secure the driven part 2 against slipping off a nut, this has no influence on the operation of the torque clutch 9. Thus, via tool 1 no axial force can be directly introduced.

As can also be gathered from FIG. 1, on their sides remote from the facing clutch surfaces, the clutch disk 16, 17 have an axial depression 24 serving to receive the sliding disk 19 and also the cup spring units 18.

FIG. 2 shows a part sectional side view of the driving part 1 of FIG. 1. In FIG. 1 the driving part 1 is shown to the right, whereas FIG. 2 shows it with the reverse orientation. With respect to the action of the tool and clutch the driving part and driven part can be interchanged, because the torque clutch acts in the same way in both directions.

As shown in FIG. 2, the driving part 1 has a first end 25 used for introducing the torque. In the embodiment shown the end 25 contains a polygonal recess 26, in which can be inserted a square, which is e.g. part of a ratchet wrench.

The part associated with the driven part 2 and remote from the first end 25 has a cylindrical outside for guiding the ring 4. To prevent a complete sliding off of the ring the bead 3 is provided and forms a shoulder 27.

The polygonal recess 26 is separated from the inner area 8 of the driving part by a partition 28, which forms the aforementioned end face 13. In the area between the end face 13 and the end facing the driven part, the inner area 8 is shaped like a regular hexagon. One edge 29 of the hexagon can be seen in FIG. 2. This hexagonal shape corresponds to the hexagonal outer shape of the associated clutch disk 16. The hexagonal shape is one of the possible shapes for the construction of the outside of the clutch disk and the inside of the driving part 1. Obviously other shapes are possible for bringing about the rotary driving of the clutch disk.

The driven part 2 shown in FIG. 3 has a similar construction to the driving part 1. At its end remote from the driving part it contains an inner recess 30 in the form of a regular dodecagon, which is constructed for driving a conventional hexagon bolt or nut. Here again the recess 30 is separated from the inner area 8 by a partition 31 forming the end face 11. Here again the inner area is shaped like a regular hexagon, which is represented by an edge 32. Once again other shapes of the cross-section through said portion of the driven part 2 are possible. The cross-sections of the two parts of the inner area 8 need not be identical, because one clutch disk 16 only cooperates with one part, i.e. the driving part or the driven part, whereas the other clutch disk 17 is only in engagement with the in each case other part.

FIGS. 4 and 5 show the two clutch disks 16, 17 in the same orientation as in FIG. 1. The facing clutch surfaces 33 have a type of saw-tooth shape, the saw teeth naturally passing along a radius, cf. also FIG. 6, which shows the two clutch surfaces 33 in end view. In the case of the two clutch disks 16, 17 the outer circumference is constructed in the form of a regular hexagon. As has already been stated, use can also be made of other shapes and in particular the outer shapes of both clutch disks can differ from one another. Only the facing clutch surfaces 33 must be matched to one another.

The clutch disks have an inner opening 34, whose internal diameter roughly corresponds to the external diameter of the journal 10. The clutch disks must be both rotatable and also axially displaceable with respect to the journal 10. The parts of the clutch surfaces having the inclined faces start at a radius, which is somewhat larger than the radius of the inner opening 34. Thus, a smooth-surfaced area 35 is formed round the rim of the opening 34 and on it could be placed a narrow ring. Such a ring could be used for pressing apart to a certain extent the clutch disks in their engaged state, cf. FIG. 1, in order to e.g. increase the pretension of the cup springs 18. This can also be used for modifying the clutch release value.

FIG. 7 shows the clutch journal 10 in the same orientation as in FIG. 1. In its smooth-surfaced area the journal has a diameter which is somewhat smaller than the diameter of the inner opening 34. The elongated hole 22 is positioned in such a way that it covers the possible position of the stop nut used for adjusting the clutch release torque.

FIGS. 8 and 9 show the stop nut, FIG. 8 being an angled section along line VIII-VIII in FIG. 9. The stop nut 20 has an internal thread 36 corresponding to the external thread 15 of the journal 10. In principle the stop nut can be adjusted in stepless manner, so that the clutch release value can be very finely adjusted. To secure it against loosening, it has a cross hole 37 running along a diameter and through which can be engaged the journal 21. This journal is then also passed through the elongated hole 22. As a result the nut can be secured in steps representing a half-pitch of the thread 15. To prevent slipping out of the pin or journal 21, a circlip 23 is placed in a circumferential groove 38.

The nut stop 20 has two parallel key faces 39 on which one can act with a tool.

In FIG. 10 and 11 is to be seen that the outer surfaces 41 of the clutch disk of this embodiment are curved outwards. This outward bulging is very advantageous for the clutch. The bulging is present in the longitudinal direction, see FIG. 10, and in the cross direction, see FIG. 11.

1. Tool for transmitting a torque having a driving part for introducing a torque, a driven part for torque reduction, which is connected in rotary and axially displaceable manner to the driving part, as well as with a torque-limiting clutch, whose inlet used for torque introduction is connected to the driving part and whose outlet used for torque reduction can be connected in non-rotary manner to the driven part of the tool, wherein the clutch is positioned in such a way that it does not participate in the transmission of axial forces with the aid of the tool.

2. Tool according to claim 1; wherein the clutch is not connected in the axial direction to the driving part or to the driven part.

3. Tool according to claim 1, wherein the clutch is axially displaceably held with respect to the tool.

4. Tool according to claim 1, wherein the driving part is constructed in such a way that it is connectable with a driving tool either directly or by means of a connecting element.

5. Tool according to claim 11, wherein the driven part is constructed as a pinion.

6. Tool according to one of the preceding claims, wherein the driving part and driven part is constructed as a sleeve, in whose in particular combined inner area is housed the clutch.

7. Tool according to claim 6; wherein the sleeves has a non-circular inner cross-section adapted to the outer cross-section of the inlet or outlet of the clutch.

8. Tool according to claim 7, wherein the cross-section is shaped like a polygon.

9. Tool according to claim 6, wherein the inside cross-section of both sleeves is identical.

10. Tool according to claim 1, wherein the release value of the clutch is adjustable.

11. Tool according to claim 1, wherein the clutch has a journal provided on both sides with a stop member and on which are displaceably mounted two clutch disks, which are pressed against one another by at least one spring.

12. Tool according to claim 11, wherein the release value of the clutch can be adjusted by replacing the spring.

13. Tool according to claim 11, wherein two springs are used in such a way that each spring is positioned between a stop member and a clutch disk.

14. Tool according to claim 11, wherein at least one stop member is adjustable, particularly in stepless or finely stepped manner in the longitudinal direction of the journal.

15. Tool according to claim 11, wherein the position of the clutch disks can be modified in the longitudinal direction of the journal without changing the release value of the clutch.

16. Tool according to claim 11, wherein a sliding disk is positioned between the spring and the associated clutch disk and/or the associated stop member.

17. Tool according to claim 11, wherein one of the two stop members is formed by a nut.

18. Tool according to claim 11, wherein the facing sides of the clutch disks have a saw-tooth system.

19. Tool according to claim 11, wherein the tooth system of the clutch surfaces emanates radially from a radius larger than the radius of the opening of the clutch disks receiving the journal.

20. Tool according to claim 11, wherein the outer circumference of the clutch disks forms the inlet or outlet of the clutch used for introducing or reducing torque.

21. Tool according to claim 1, wherein the clutch is constructed as a sleeve, in whose interior is located the driving part and driven part of the tool.

22. Tool according to claim 8, wherein the outer surfaces of the input and output of the clutch are bulged outwards.
